(19) United States
(12) Patent Application Publication
(10) Pub. No.: US 2017/0085776 A1
(43) Pub. Date: Mar. 23, 2017

(54) IMAGING APPARATUS AND METHOD FOR CONTROLLING IMAGING APPARATUS

(71) Applicant: CANON KABUSHIKI KAISHA, Tokyo (JP)

(72) Inventor: Takahiro Iwasaki, Port Washington, NY (US)

(21) Appl. No.: 15/126,263

(22) PCT Filed: Feb. 24, 2015
(86) PCT No.: PCT/JP2015/000917

§ 371 Date: Sep. 14, 2016

(30) Foreign Application Priority Data
Mar. 17, 2014 (JP) 2014-054183

(51) Int. Cl. H04N 5/232; H04N 5/262; H04N 7/18

(52) U.S. Cl. CPC H04N 5/23206; H04N 7/183; H04N 5/23216; H04N 5/2628

(57) ABSTRACT

An imaging apparatus includes an image rotation unit configured to rotate a captured image, an imaging range change unit configured to change an imaging range of an imaging unit according to an external command, a coordinate rotation unit configured to rotate a coordinate used for changing a position of the imaging range by the imaging range change unit, a first interface configured to change a rotation angle of the image rotation unit according to an external command, and a second interface configured to change a rotation angle of the coordinate rotation unit according to an external command. When one of the rotation angles is specified by the first interface or the second interface and the other of the rotation angles is not specified by the first interface or the second interface, the imaging apparatus performs control so as to determine the both rotation angles based on this specified rotation angle.

### TECHNICAL FIELD

The present invention relates to an imaging apparatus capable of rotating and then compressing/coding an image captured by an imaging unit, and a method for controlling the imaging apparatus.

### BACKGROUND ART

When imaging apparatuses for monitoring use are installed, they are often installed in an orientation that is not necessarily a normal upright orientation. For example, when such an imaging apparatus is installed in an inverted orientation (i.e., upside down orientation), an output image from the imaging apparatus is output upside down compared to an output image when the imaging apparatus is installed in the normal upright orientation. One known implementation method for solving this problem is recording an image input from an image sensor and arbitrarily changing a method for reading out this image to output this image while vertically reversing (rotating) the image, thereby outputting the image according to the orientation of the imaging apparatus.

For example, PTL 1 discusses an idea that allows an imaging apparatus capable of vertically reversing an image like the above-described image to desirably change a measurement range for performing an exposure setting and the like of the image.

Further, conventionally, a group of commands that allows an external apparatus to instruct an imaging apparatus to change a setting and start distributing an image has been implemented on imaging apparatuses that transmit captured images to external apparatuses. In recent years, a group of commands defined in the standard formulated by Open Network Video Interface Forum (ONVIF) has been known as an example of such a group of commands.

The above-described group of commands includes a command by which the external apparatus instructs the imaging apparatus to rotate an orientation of the output image. For example, a SetVideoSourceConfiguration command is defined in the above-described ONVIF standard as such a command. Further, a command for changing an imaging range of the imaging apparatus is defined in the ONVIF standard. Further, a command for reversing a coordinate system regarding the command for changing the imaging range according to the orientation of the imaging apparatus is included in the group of commands defined in the ONVIF standard. For example, according to the above-described ONVIF standard, an AbsoluteMove command is defined as the former command, and a SetConfiguration command is defined as the latter command.

### CITATION LIST

### Patent Literature

PTL 1: Japanese Patent Application Laid-Open No. 2008-153842

### SUMMARY OF INVENTION

### Technical Problem

Conventionally, there have been imaging apparatuses that support both the command for rotating the orientation of the output image and the command for reversing the coordinate system regarding the command for changing the imaging range, and perform control so as to allow the external apparatus to change these orientations independently of each other. On the other hand, there have been imaging apparatuses that support only the former command and perform control so as to rotate the both orientations altogether by the former command. Further, as the external apparatus that attempts to operate the imaging apparatus, there have been also external apparatuses that set both orientations independently of each other, and external apparatuses that rotate both orientations by operating only the former command.

This environment leads to such a problem that, although the external apparatus desires to reverse only the orientation of the output image, the imaging apparatus may also change the coordinate system regarding the command for changing the imaging range together with the orientation of the output image depending on a combination of the imaging apparatus and the external apparatus. Further, the above-described environment also leads to such a problem that, although the external apparatus desires to rotate both orientations by the command for rotating the output image, the imaging apparatus may rotate only the output image, resulting in inconsistency between the orientation of the output image and the orientation of the coordinate system regarding the command for changing the imaging range.

### Solution to Problem

To solve at least one of the above-described problems, according to an aspect of the present invention, an imaging apparatus includes an imaging unit configured to capture an image of an object that is formed by an imaging optical system, an image rotation unit configured to rotate the captured image captured by the imaging unit, an imaging range change unit configured to change an imaging range of the imaging unit according to an external command, a coordinate rotation unit configured to rotate a coordinate used for changing a position of the imaging range by the imaging range change unit, a first interface configured to change a rotation angle of the image rotation unit according to an external command, and a second interface configured to change a rotation angle of the coordinate rotation unit according to an external command, When one of the rotation angles is specified by the first interface or the second interface and the other of the rotation angles is not specified by the first interface or the second interface, the imaging apparatus performs control so as to determine the both rotation angles based on this specified rotation angle.

Further features of the present invention will become apparent from the following description of exemplary embodiments with reference to the attached drawings.

### BRIEF DESCRIPTION OF DRAWINGS

FIG. 1 is a system configuration diagram illustrating a configuration of an imaging system according to each of first, second, and third exemplary embodiments of the present invention.

FIG. 2A is a block diagram illustrating an internal configuration of a monitoring camera included in the imaging system according to each of the first, second, and third exemplary embodiments of the present invention.

FIG. 2B is a block diagram illustrating an internal configuration of a client apparatus included in the imaging system according to each of the first, second, and third exemplary embodiments of the present invention.

FIG. 3 illustrates an overview of parameters stored in the monitoring camera according to each the first, second, and third exemplary embodiments of the present invention.

FIG. 4A illustrates details of parameters according to each of the first, second, and third exemplary embodiments of the present invention.

FIG. 4B illustrates details of parameters according to each of the first, second, and third exemplary embodiments of the present invention.

FIG. 4C illustrates details of parameters according to each of the first, second, and third exemplary embodiments of the present invention.

FIG. 5 illustrates details of parameters according to each of the first, second, and third exemplary embodiments of the present invention.

FIG. 6A illustrates details of parameters according to each of the first, second, and third exemplary embodiments of the present invention.

FIG. 6B illustrates details of parameters according to each of the first, second, and third exemplary embodiments of the present invention.

FIG. 6C illustrates details of a parameter according to each of the first, second, and third exemplary embodiments of the present invention.

FIG. 7 is a sequence diagram between the monitoring camera and the client apparatus according to each of the first, second, and third exemplary embodiments of the present invention.

FIG. 8 is a sequence diagram between the monitoring camera and the client apparatus according to each of the first, second, and third exemplary embodiments of the present invention.

FIG. 9 is a sequence diagram between the monitoring camera and the client apparatus according to each of the first, second, and third exemplary embodiments of the present invention.

FIG. 10 is a sequence diagram between the monitoring camera and the client apparatus according to each of the first, second, and third exemplary embodiments of the present invention.

FIG. 11 illustrates rotated image data distributed by the monitoring camera according to each of the first, second, and third exemplary embodiments of the present invention.

FIG. 12 illustrates rotated pan-tilt coordinate systems regarding an AbsoluteMove command of the monitoring camera according to each of the first, second, and third exemplary embodiments of the present invention.

FIG. 13 is a flowchart illustrating how the monitoring camera operates during main processing according to each of the first, second, and third exemplary embodiments of the present invention.

FIG. 14 is a flowchart illustrating how the monitoring camera operates during distribution image generation processing according to the first exemplary embodiment of the present invention.

FIG. 15 is a flowchart illustrating how the monitoring camera operates upon receiving the AbsoluteMove command according to the first exemplary embodiment of the present invention.

FIG. 16 illustrates a distribution image rotation setting screen of the client apparatus according to each of the first, second, and third exemplary embodiments of the present invention.

FIG. 17 is a flowchart illustrating how the client apparatus operates during processing for displaying the distribution image rotation setting screen illustrated in FIG. 16 according to each of the first, second, and third exemplary embodiments of the present invention.

FIG. 18 is a flowchart illustrating how the monitoring camera operates during distribution image generation processing according to the second exemplary embodiment of the present invention.

FIG. 19 is a flowchart illustrating how the monitoring camera operates upon receiving the AbsoluteMove command according to the second exemplary embodiment of the present invention.

FIG. 20 is a flowchart illustrating how the monitoring camera operates during distribution image generation processing according to the third exemplary embodiment of the present invention.

FIG. 21 is a flowchart illustrating how the monitoring camera operates upon receiving the AbsoluteMove command according to the third exemplary embodiment of the present invention.

FIG. 22A illustrates a conversion calculation expression for converting pan and tilt coordinate values according to each of the first, second, and third exemplary embodiments of the present invention.

FIG. 22B illustrates a conversion calculation expression for converting the pan and tilt coordinate values according to each of the first, second, and third exemplary embodiments of the present invention.

FIG. 22C illustrates a conversion calculation expression for converting the pan and tilt coordinate values according to each of the first, second, and third exemplary embodiments of the present invention.

### DESCRIPTION OF EMBODIMENTS

In the following description, exemplary embodiments of the present invention will be described with reference to the accompanying drawings.

### First Exemplary Embodiment

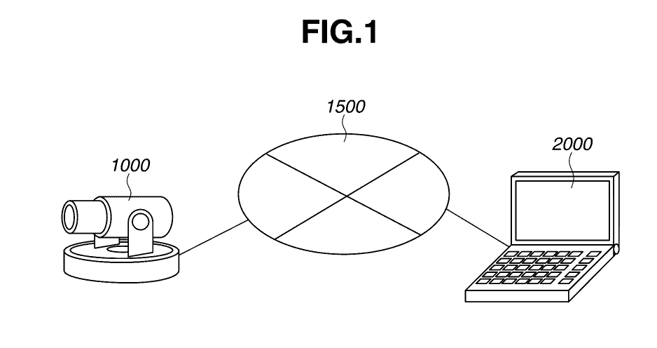

FIG. 1 is a system configuration diagram illustrating an imaging system including a monitoring camera 1000, which corresponds to an imaging apparatus, and a client apparatus 2000 according to a first exemplary embodiment of the present invention. The client apparatus 2000 corresponds to an external apparatus in the present exemplary embodiment. The monitoring camera 1000 and the client apparatus 2000 are connected to each other mutually communicably via an Internet Protocol (IP) network 1500.

The client apparatus 2000 transmits various kinds of commands such as a change in imaging parameters that will be described below, and a start of video streaming to the monitoring camera 1000. The monitoring camera 1000 transmits responses and a video stream in response to these commands to the client apparatus 2000.

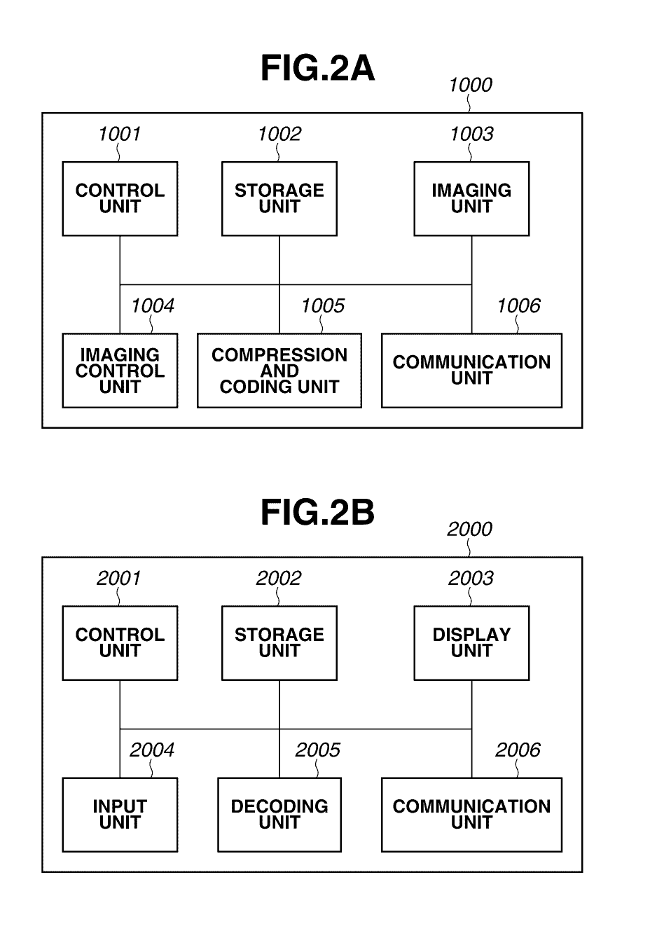

FIG. 2A illustrates an internal configuration of the monitoring camera 1000.

Referring to FIG. 2A, a control unit 1001 controls the entire monitoring camera 1000. The control unit 1001 is embodied by, for example, a central processing unit (CPU).

A storage unit 1002 is used as an area for storing various kinds of data, such as an area for storing a program to be executed mainly by the control unit 1001, a work area used during the execution of the program, and an area for storing image data generated by an imaging unit 1003 that will be described below.

The imaging unit 1003 converts an analog signal acquired by capturing an image of an object that is formed by an imaging optical system of the monitoring camera 1000 into digital data, and outputs the converted data to the storage unit 1002 as a captured image. When the captured image is output to the storage unit 1002, the control unit 1001 receives an image acquisition event from the imaging unit 1003.

An imaging control unit 1004 is used to change an imaging range of the imaging unit 1003 in a tilt direction and a pan direction according to a pan coordinate value and a tilt coordinate value input by the control unit 1001.

A compression and coding unit 1005 generates image data by performing compression and coding processing on the captured image output from the imaging unit 1003 based on a Joint Photographic Experts Group (JPEG) format, an H.264 format, or the like, and outputs the generated image data to the storage unit 1002.

A communication unit 1006 is used when the respective control commands are received from the external apparatus, and when the responses to the respective control commands are transmitted to the external apparatus. When a command is received from the external apparatus, the control unit 1001 receives a command reception event from the communication unit 1006.

FIG. 2B illustrates an internal configuration of the client apparatus 2000.

Referring to FIG. 2B, a control unit 2001 is embodied by, for example, a CPU, and controls the entire client apparatus 2000.

A storage unit 2002 is used as an area for storing various kinds of data, such as an area for storing a program to be executed mainly by the control unit 2001 and a work area used during the execution of the program.

A display unit 2003 is embodied by, for example, a liquid crystal display (LCD), an organic light emitting (EL) display, or the like. The display unit 2003 displays various setting screens including a distribution image setting screen that will be described below, a viewer for viewing a video image received from the monitoring camera 1000, various kinds of messages, and the like to a user of the client apparatus 2000.

An input unit 2004 includes, for example, a button, an arrow key, a touch panel, and a mouse. The input unit 2004 notifies the control unit 2001 of a content of a screen operation performed by the user.

A decoding unit 2005 decodes the compressed and coded image data received via a communication unit 2006 based on the JPEG format, the H.264 format, or the like, and stores the decoded data into the storage unit 2002.

The communication unit 2006 is used when the respective control commands are transmitted to the monitoring camera 1000, and when the responses and the video stream in response to the respective control commands are received from the monitoring camera 1000.

In this manner, the internal configurations of the monitoring camera 1000 and the client apparatus 2000 have been described with reference to FIGS. 2A and 2B, but the processing blocks illustrated in FIGS. 2A and 2B illustrate merely one example of the monitoring camera and the client apparatus according to the present exemplary embodiment, and the monitoring camera and the client apparatus in the present exemplary embodiment are not limited thereto. The monitoring camera and the client apparatus in the present exemplary embodiment can be modified and changed in various manners within the scope and the spirit of the present invention. For example, the monitoring camera and the client apparatus in the present exemplary embodiment may include an audio input, unit, an audio output unit, and/or an image analysis processing unit.

Names and contents of commands, parameters, and the like used in the present exemplary embodiment will be described below.

Hereinafter, VideoSourceConfiguration may be abbreviated as VSC, VideoEncoderConfiguration may be abbreviated as VEC, and PTZConfiguration may be abbreviated as PTZC.

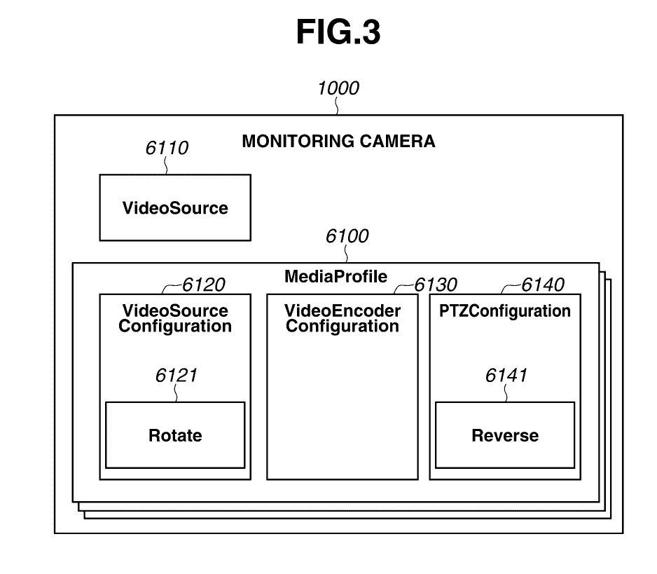

FIG. 3 illustrates a structure of the parameters stored in the monitoring camera 1000 according to the present exemplary embodiment.

The monitoring camera 1000 has a MediaProfile 6100. The MediaProfile 6100 is a set of parameters for storing various kinds of setting items required for video distribution by the monitoring camera 1000 into the storage unit 1002 while associating them with the MediaProfile 6100. The MediaProfile 6100 includes a ProfileToken that is an identification (ID) of the MediaProfile 6100, and links to the various kinds of setting items including a VSC, a VEC, and a PTZC that will be described below. The monitoring camera 1000 can have a plurality of MediaProfiles 6100.

A VideoSource 6110 is a set of parameters indicating a performance of the imaging unit 1003 included in the monitoring camera 1000. The VideoSource 6110 includes a VideoSourceToken that is an ID of the VideoSource 6110, and a Resolution indicating a resolution of the image data that can be output by the imaging unit 1003.

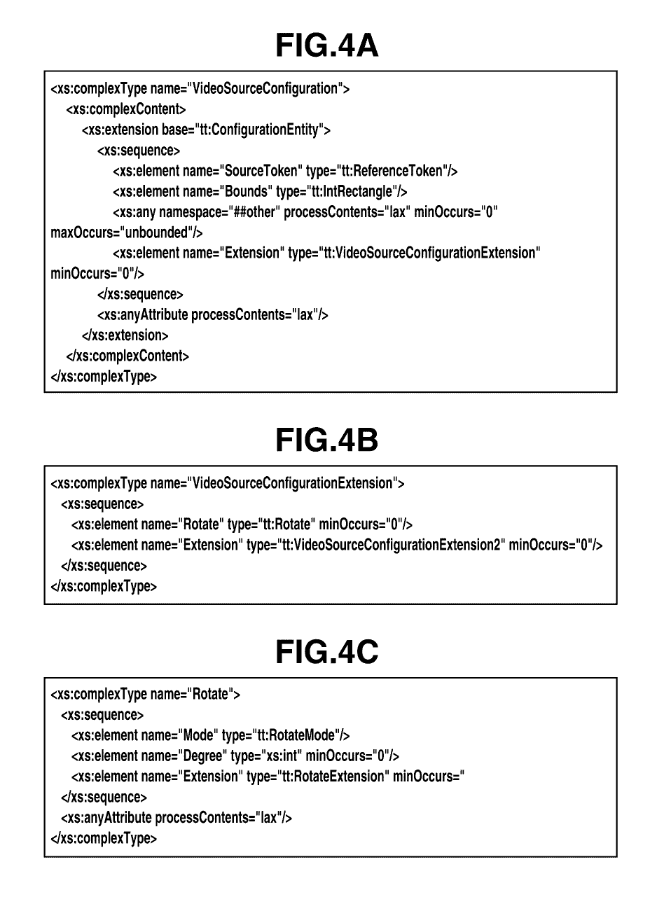

A VideoSourceConfiguration 6120 is a set of parameters for associating the VideoSource 6110 stored in the monitoring camera 1000 with the MediaProfile 6100. The VSC 6120 includes a Rotate parameter 6121 for specifying an angle by which the control unit 1001 rotates the image data clockwise when inputting the image data output from the imaging unit 1003 to the storage unit 1002 into the compressing and coding unit 1005. The content of the VSC 6120 is illustrated in FIG. 4A, and will be described below.

A VideoEncoderConfiguration 6130 is a set of parameters for associating settings of the compression and coding unit 1005 regarding the compression and coding of the image data with the MediaProfile 6100.

The VEC 6130 includes a Token that is an ID of the VEC 6130, a Type for specifying the compression and coding method, and a Resolution for specifying a resolution of the output image. The VEC 6130 may further include a Quality for specifying a quality of the compression and coding, a FramerateLimit for specifying a maximum frame rate of the output image, a BitrateLimit for specifying a maximum bitrate, and the like, but these parameters are not described in the present exemplary embodiment.

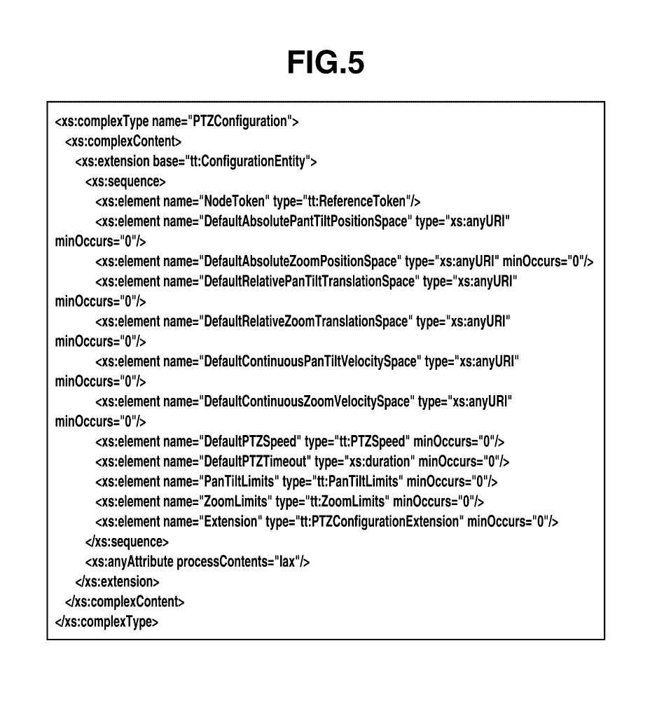

A PTZConfiguration 6140 is a set of parameters for associating parameters regarding a pan, tilt, and zoom function for changing the imaging range of the imaging unit 1003 of the monitoring camera 1000 with the MediaProfile 6100. The PTZConfiguration 6140 includes a Reverse 6141 for rotating a pan-tilt coordinate system. The content of the PTZC 6140 is illustrated in FIG. 5, and will be described below.

For example, according to the MediaProfile 6100 illustrated in FIG. 3, the monitoring camera 1000 compresses and codes the image data output based on the content of the VideoSource 6110 and the content of the VSC 6120 according to the parameters regarding the compression and coding method and the like that are set in the VEC 6130. Further, the monitoring camera 1000 distributes the compressed and coded image data to the client apparatus 2000 via the communication unit 1006.

FIGS. 4A, 4B, and 4C, FIG. 5, and FIGS. 6A, 6B, and 6C illustrate details of arguments in the respective commands transmitted and received between the monitoring camera 1000 and the client apparatus 2000, and details of the parameters.

FIG. 4A illustrates the content of the VSC 6120. The VSC 6120 includes a SourceToken for specifying the Token of the VideoSource 6110 associated with the MediaProfile 6100. Further, the VSC 6120 includes a Bounds for specifying a position and a size based on which the image is segmented when the control unit 1001 inputs the image data output from the imaging unit 1003 into the compression and coding unit 1005. Further, the VSC 6120 includes an Extension that includes an extended parameter. The content of the Extension is illustrated in FIG. 4B.

FIG. 4B illustrates the content of a VSCExtension that is referred to in the VSC 6120 as the Extension. The VSCExtension includes the Rotate parameter 6121. The Rotate parameter 6121 is illustrated in detail in FIG. 4C.

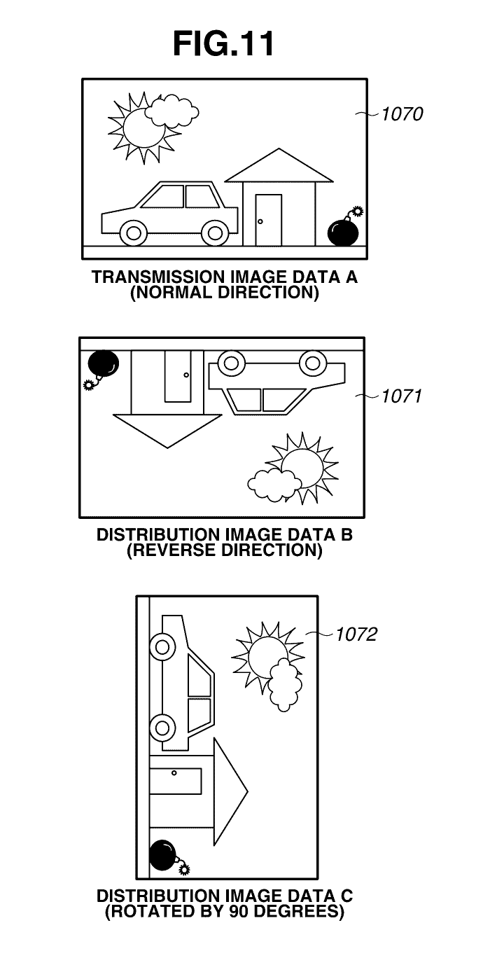

FIG. 4C illustrates the content of the Rotate parameter 6121 included in the VSC 6120. The Rotate parameter 6121 includes a Mode for switching enablement and disablement of a rotation. Options, ON, OFF, and AUTO can be specified as the Mode. When the option ON is specified, the control unit 1001 rotates the image data output from the imaging unit 1003 to the storage unit 1002 by an angle specified in a Degree that will be described below, and inputs the rotated image data to the compression and coding unit 1005. As a result, for example, if the imaging unit 1003 outputs image data 1070 illustrated in FIG. 11 with 90 degrees specified in the Degree, image data as indicated by image data 1072 is distributed from the monitoring camera 1000. The Degree is a parameter for arbitrarily setting the rotation angle of the image when the option ON is specified as the Mode parameter. In a case where the Degree is omitted, the control unit 1001 employs 180 degrees.

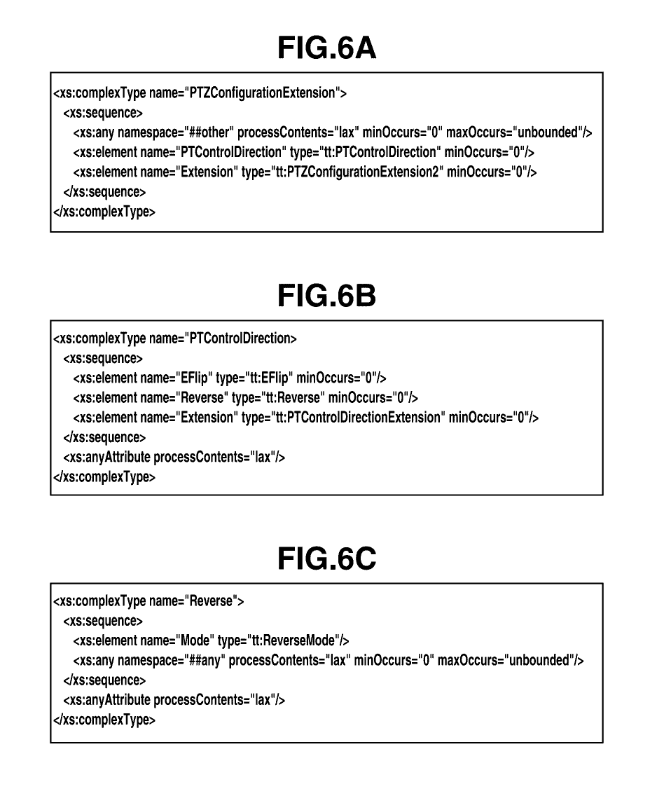

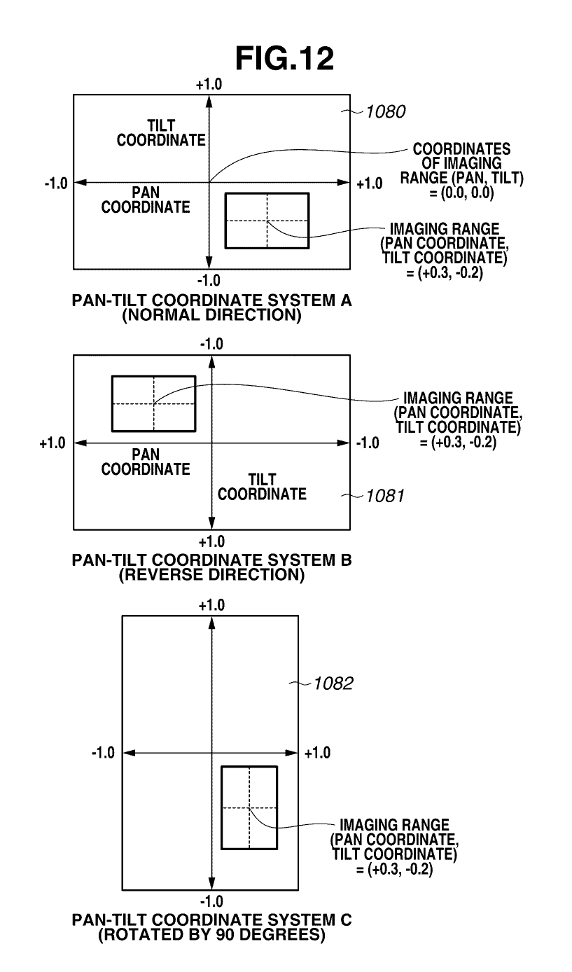

FIG. 5 illustrates the content of the PTZC 6140. The PTZC 6140 includes a NodeToken that indicates an ID of a pan, tilt, and zoom mechanism of the monitoring camera 1000 that is a target of this PTZC 6140. Further, the PTZC 6140 includes a DefaultAbsolutePantTiltPositionSpace that is a parameter for specifying the pan-tilt coordinate system used in an AbsoluteMove command as default. Assume that the monitoring camera 1000 according to the present exemplary embodiment constantly uses a normalized coordinate system as indicated by a coordinate system 1080 illustrated in FIG. 12. More specifically, assume that the monitoring camera 1000 uses a coordinate system normalized in such a manner that a horizontal direction and a vertical direction in a default orientation of the monitoring camera 1000 correspond to the pan coordinate and the tilt coordinate, respectively, a center in an entire range that the imaging unit 1003 can image is set as an origin (the pan coordinate, the tilt coordinate)=(0, 0), and an entire driving range is set to a range of −1.0 to +1.0 for both the pan coordinate and the tilt coordinate. FIGS. 6A, 6B, and 6C illustrate the content of a PTZConfigurationExtension that is referred to in the PTZC 6140 as an Extension. The PTZC 6140 further includes the Extension that includes an extended parameter. The content of the Extension is illustrated in FIGS. 6A, 6B, and 6C. Descriptions of other parameters included in the PTZC 6140 are omitted herein.

FIGS. 6A, 6B, and 6C illustrate the content of the PTZCExtension that is referred to in the PTZC 6140 as the Extension. The PTZCExtension includes a PTControlDirection parameter for controlling a direction of the above-described pan-tilt coordinate system. The PTControlDirection is illustrated in FIG. 6B, and will be described in detail below.

FIG. 6B illustrates the content of the PTControlDirection in the Extension of the PTZC 6140. The PTControlDirection includes the Reverse 6141. The Reverse 6141 is illustrated in detail in FIG. 6C, and will be described in detail below. Descriptions of other parameters included in the PTControlDirection are omitted herein.

FIG. 6C illustrates the content of the Reverse 6141 in the PTControlDirection. The Reverse parameter 6141 is a parameter for reversing the direction of the above-described pan-tilt coordinate system, and includes a Mode for switching enablement and disablement of the reverse. Options, OFF, ON, and AUTO can be specified as the Mode. The option OFF causes the monitoring camera 1000 not to reverse the direction of the pan-tilt coordinate system. The option ON causes the monitoring camera 1000 to reverse the direction of the pan-tilt coordinate system. The option AUTO causes the monitoring camera 1000 to reverse the direction of the pan-tilt coordinate system based on a predetermined condition.

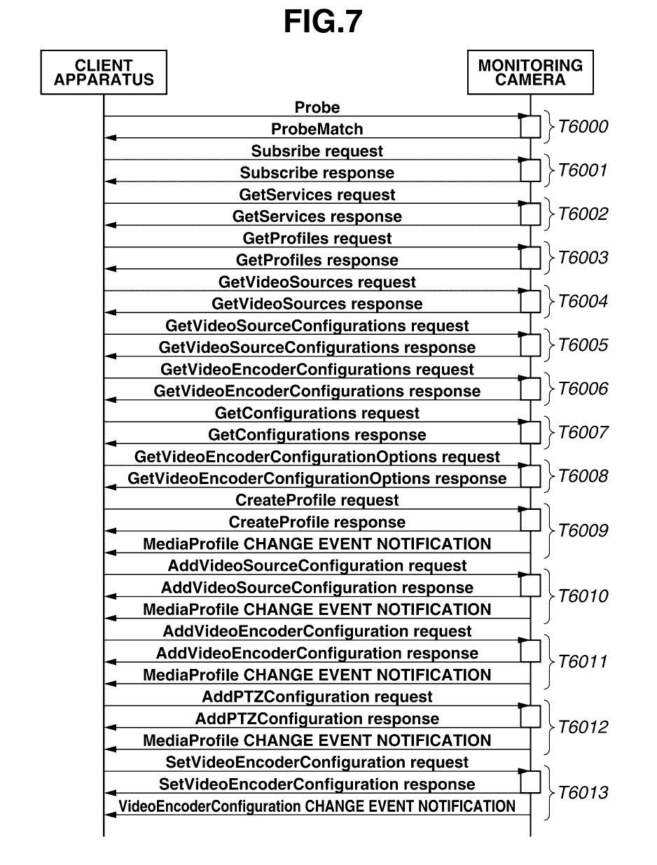

FIGS. 7, 8, 9, and 10 illustrate typical command sequences performed between the monitoring camera 1000 and the client apparatus 2000.

FIG. 7 illustrates a typical command sequence from establishing a connection to setting the parameters that is performed between the monitoring camera 1000 and the client apparatus 2000.

In transaction T6000, a network device connection is established. The client apparatus 2000 transmits a Probe command for connecting the network device, to the network 1500 in a unicast or multicast manner. The monitoring camera 1000 connected to the network 1500 returns a ProbeMatch response indicating that the monitoring camera 1000 is ready for reception of a command, to the client apparatus 2000.

In transaction T6001, the client apparatus 2000 transmits a Subscribe command. By this command, the client apparatus 2000 instructs the monitoring camera 1000 to distribute an event.

In transaction T6002, the client apparatus 2000 transmits a GetServices command. The client apparatus 2000 transmits the GetServices command for acquiring functions supported by the monitoring camera 1000, to the monitoring camera 1000 that has returned the ProbeMatch response. The monitoring camera 1000 returns a GetServices response, thereby providing a list of functions supported by the monitoring camera 1000 to the client apparatus 2000.

In transaction T6003, the client apparatus 2000 transmits a GetProfiles command. By this command, the client apparatus 2000 acquires a list of MediaProfiles 6100 that the monitoring camera 1000 has.

In transaction T6004, the client apparatus 2000 transmits a GetVideoSources command. By this command, the client apparatus 2000 acquires a list of VideoSources 6110 that the monitoring camera 1000 has.

In transaction T6005, the client apparatus 2000 transmits a GetVSCs command. By this command, the client apparatus 2000 acquires a list of VSCs 6120 that the monitoring camera 1000 has.

In transaction T6006, the client apparatus 2000 transmits a GetVECs command. By this command, the client apparatus 2000 acquires a list of VECs 6130 that the monitoring camera 1000 has.

In transaction T6007, the client apparatus 2000 transmits a GetConfigurations command. By this command, the client apparatus 2000 acquires a list of PTZCs 6140 that the monitoring camera 1000 has.

In transaction T6008, the client apparatus 2000 transmits a GetVECOptions command. By this command, the client apparatus 2000 acquires setting ranges and options settable to the respective parameters of the VEC 6130 that the monitoring camera 1000 can accept.

In transaction T6009, the client apparatus 2000 transmits a CreateProfile command. By this command, the client apparatus 2000 creates a new MediaProfile 6100 in the monitoring camera 1000, and acquires the ProfileToken thereof. After performing processing regarding this command, the monitoring camera 1000 transmits a MediaProfile change notification event to notify the client apparatus 2000 in the network 1500 that some change is made to the MediaProfile 6100.

In transactions T6010, T6011, and T6012, the client apparatus 2000 transmits an AddVSC command, an AddVEC command, and an AddPTZC command, respectively. The client apparatus 2000 can associate a desired VSC 6120, a desired VEC 6130, and a desired PTZC 6140 with a specified MediaProfile 6100 by specifying the respective IDs of the VSC 6120, the VEC 6130, and the PTZC 6140 in these commands. After performing processing regarding each of these commands, the monitoring camera 1000 transmits the MediaProfile change notification event to notify the client apparatus 2000 in the network 1500 that some change is made to the MediaProfile 6100.

In transaction T6013, the client apparatus 2000 transmits a SetVEC command. By this command, the client apparatus 2000 changes the respective parameters of the VEC 6130 based on the information acquired in transaction T6008. After performing processing regarding this command, the monitoring camera 1000 transmits a VEC change notification event to notify the client apparatus 2000 in the network 1500 that some change is made to the VEC 6130.

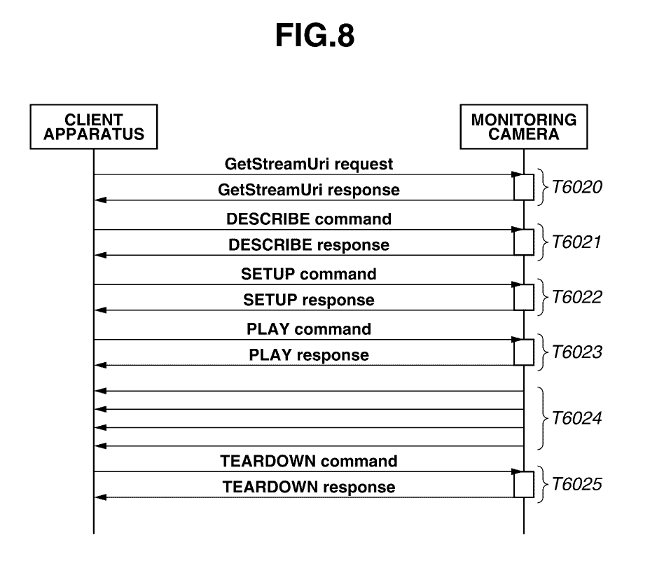

FIG. 8 illustrates a typical command sequence for distributing an image that is performed between the monitoring camera 1000 and the client apparatus 2000.

In transaction T6020, the client apparatus 2000 transmits a GetStreamUri command. By this command, the client apparatus 2000 acquires an address (Uniform Resource Identifier (URI)) for acquiring a stream to be distributed from the monitoring camera 1000 based on the settings of the specified MediaProfile 6100.

In transaction T6021, the client apparatus 2000 transmits a DESCRIBE command. The client apparatus 2000 requests and acquires information about a content to be streamed from the monitoring camera 1000 by executing this command with use of the URI acquired in transaction T6020.

In transaction T6022, the client apparatus 2000 transmits a SETUP command. The execution of this command with use of the URI acquired in transaction T6020 allows a stream transmission method including a session number to be shared between the client apparatus 2000 and the monitoring camera 1000.

In transaction T6023, the client apparatus 2000 transmits a PLAY command. The client apparatus 2000 requests a start of the stream to the monitoring camera 1000 by executing this command with use of the session number acquired in transaction T6022.

In transaction T6024, the monitoring camera 1000 distributes the stream. The monitoring camera 1000 distributes the stream requested to be started in transaction T6023 according to the transmission method shared in transaction T6022. At this time, the control unit 1001 of the monitoring camera 1000 rotates the image data acquired from the imaging unit 103 based on the Rotate parameter 6121 in the VSC 6120 during distribution image generation processing, and then distributes the rotated image data. The distribution image generation processing will be described in detail below.

In transaction T6025, the client apparatus 2000 transmits a TEARDOWN command. The client apparatus 2000 requests a stop of the stream to the monitoring camera 1000 by executing this command with use of the session number acquired in transaction T6022.

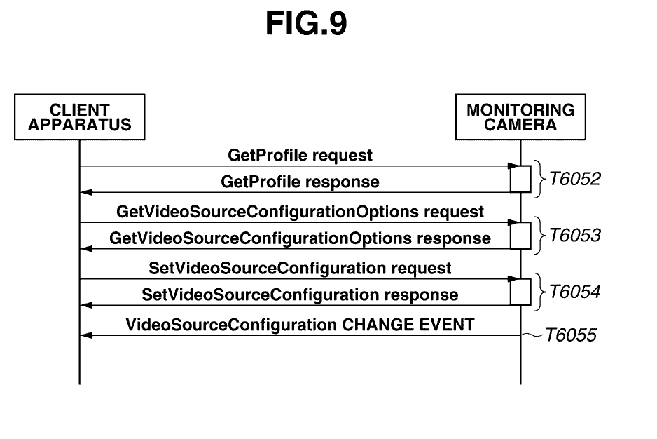

FIG. 9 illustrates a typical command sequence for setting the Rotate parameter 6121 that is performed between the monitoring camera 1000 and the client apparatus 2000.

In transaction T6052, the client apparatus 2000 transmits a GetProfile command. By this command, the client apparatus 2000 specifies the ID of a MediaProfile 6100 to be set as a target of video distribution among the MediaProfiles 6100 acquired from the monitoring camera 1000 in transaction T6003 or the MediaProfile 6100 created in transaction T6009, and acquires this MediaProfile 6100 from the monitoring camera 1000.

In transaction T6053, the client apparatus 2000 transmits a GetVSCOptions command. By this command, the client apparatus 2000 acquires setting ranges and options settable to the respective parameters of the VSC 6120 that the monitoring camera 1000 can accept. In response to this command, the monitoring camera 1000 returns the options for the respective parameters settable to the image rotation, i.e., the Rotate 6121 to the client apparatus 2000. In the present exemplary embodiment, assume that the monitoring camera 1000 returns ON, OFF, and AUTO as the options for the Mode of the Rotate 6121, and 0 degrees, 90 degrees, 180 degrees, and 270 degrees as the options for the Degree.

In transaction T6054, the client apparatus 2000 transmits a SetVSC command. By this command, the client apparatus 2000 updates the parameters of the VSC 6120 that include the Rotate 6121 based on the settable ranges and options acquired in transaction T6053. Processing regarding this command will be described in detail below. After performing the processing regarding this command, the monitoring camera 1000 transmits a VSC change notification event 6055 to notify the client apparatus 2000 in the network 1500 that some change is made to the VSC 6120.

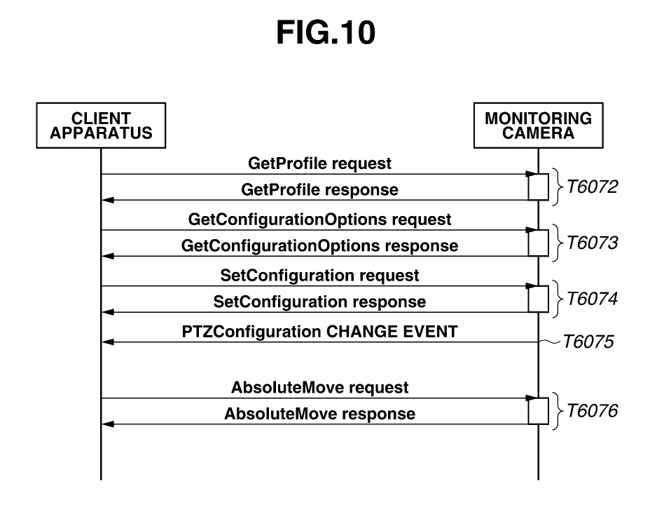

FIG. 10 illustrates a typical command sequence for setting the Reverse parameter 6141 that is performed between the monitoring camera 1000 and the client apparatus 2000.

In transaction T6072, the client apparatus 2000 transmits the GetProfile command. This transaction is similar to transaction T6052.

In transaction T6073, the client apparatus 2000 transmits a GetPTZCOptions command. By this command, the client apparatus 2000 acquires setting ranges and options settable to the respective parameters of the PTZC 6140 that the monitoring camera 1000 can accept. In response to this command, the monitoring camera 1000 returns the options for the respective parameters settable to the reversal of the pan and tilt coordinates, i.e., the Reverse 6141 to the client apparatus 2000. In the present exemplary embodiment, assume that the monitoring camera 1000 returns ON, OFF, and AUTO as the options for the Mode of the Reverse 6141.

In transaction T6074, the client apparatus 2000 transmits a SetConfiguration command. By this command, the client apparatus 2000 updates the parameters of the PTZC 6140 that include the Reverse 6141 based on the settable ranges and options acquired in transaction T6073. Processing regarding this command will be described in detail below. After performing the processing regarding this command, the monitoring camera 1000 transmits a PTZC change notification event 6075 to notify the client apparatus 2000 in the network 1500 that some change is made to the PTZC 6140.

In transaction T6076, the client apparatus 2000 transmits the AbsoluteMove command. By this command, the client apparatus 2000 moves the imaging range to a pan-tilt position specified in the argument based on the pan and tilt coordinates specified in the DefaultAbsolutePantTiltPositionSpace included in the PTZC 6140. Processing regarding this command will be described in detail below.

FIG. 11 illustrates examples of the image that the monitoring camera 1000 distributes based on the Rotate 6121 in the VSC 6120.

The image 1070 indicates an example of a distribution image when the Rotate parameter 6121 is not set or when the Mode of the Rotate 6121 is set to OFF, assuming that the image 1070 is the image data output from the imaging unit 1003.

An image 1071 indicates an example of a distribution image when the Mode of the Rotate 6121 is set to ON, and the Degree is set to 180 degrees, assuming that the image 1070 is the image data output from the imaging unit 1003.

The image 1072 indicates an example of a distribution image when the Mode of the Rotate 6121 is set to ON, and the Degree is set to 90 degrees, assuming that the image 1070 is the image data output from the imaging unit 1003.

FIG. 12 illustrates examples of positions of the imaging range when the monitoring camera 1000 performs the processing regarding the AbsoluteMove command based on the Reverse 6141 in the PTZC 6140. The AbsoluteMove command is a command for tilting the imaging range of the monitoring camera 1000, i.e., operating the imaging range of the monitoring camera 1000 in the vertical direction, and panning the imaging range of the monitoring camera 1000, i.e., operating the imaging range of the monitoring camera 1000 in the horizontal direction. In the present exemplary embodiment, the pan and tilt coordinates in the AbsoluteMove command are defined in such a manner that the upper side and the lower side in the vertical direction correspond to a tilt(+) and a tilt(−), respectively, and the right side and the left side in the horizontal direction correspond to a pan(+) and a pan(−), respectively. In the present exemplary embodiment, assume that an orientation in which the imaging unit 1003 outputs an image as indicated by the image 1070 is a normal direction of the monitoring camera 1000, i.e., an unreversed state of the monitoring camera 1000.

The pan-tilt coordinate system 1080 indicates orientations of the pan and tilt coordinates when the Reverse parameter 6141 is not set or when the Mode of the Reverse 6141 is set to OFF. In other words, the pan-tilt coordinate system 1080 indicates orientations of the pan and tilt coordinates in the normal direction. At this time, if the monitoring camera 1000 receives the AbsoluteMove command specifying (the pan coordinate, the tilt coordinate)=(+0.3, −0.2), the imaging range of the monitoring camera 1000 is moved to a position indicated in the pan-tilt coordinate system 1080.

A pan-tilt coordinate system 1081 indicates orientations of the pan and tilt coordinates when the Mode of the Reverse parameter 6141 is set to ON. In other words, the pan-tilt coordinate system 1081 indicates orientations of the pan and tilt coordinates in a reverse direction. At this time, if the monitoring camera 1000 receives the AbsoluteMove command specifying (the pan coordinate, the tilt coordinate)=(+0.3, −0.2), the imaging range is moved to a position indicated in the pan-tilt coordinate system 1081. This setting is effective, for example, when the monitoring camera 1000 is installed in a vertically reversed orientation.

A pan-tilt coordinate system 1082 indicates orientations of the pan and tilt coordinates when the Mode of the Reverse parameter 6141 is set to OFF or AUTO, and the Mode of the Rotate parameter 6121 is set to ON with the Degree parameter set to 90 degrees. At this time, if the monitoring camera 1000 receives the AbsoluteMove command specifying (pan coordinate, tilt coordinate)=(+0.3, −0.2), the imaging range is moved to a position indicated in the pan-tilt coordinate system 1082. This setting is effective, for example, when the monitoring camera 1000 is installed on a wall surface in an orientation inclined by 90 degrees.

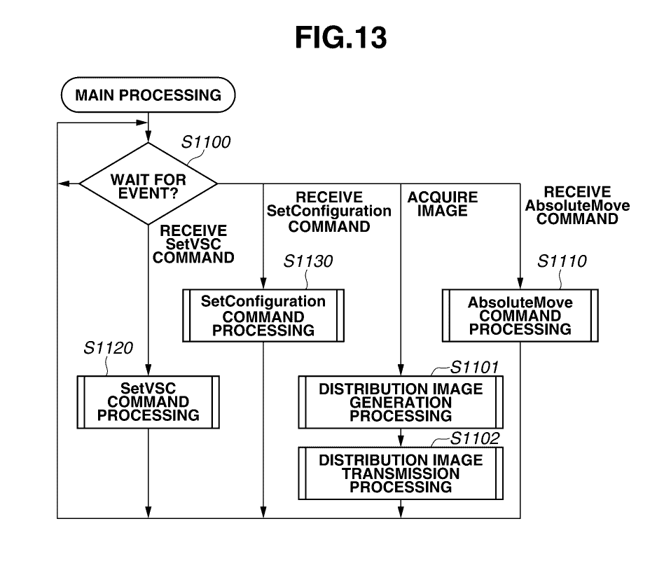

FIG. 13 is a flowchart illustrating main processing performed by the monitoring camera 1000.

In step S1100, the control unit 1001 waits for an event.

Now, processing performed if the control unit 1001 receives a SetVSC command reception event in step S1100 (RECEIVE SetVSC COMMAND in step S1100) will be described.

In step S1120, the control unit 1001 performs the SetVSC command processing. The SetVSC command processing is not illustrated in detail. During the SetVSC command processing, the control unit 1001 stores a VSC 6120 specified in an argument in the received SetVSC command into the storage unit 1002, and returns a response to the client apparatus 2000.

After step S1120 is performed, the processing returns to step S1100. Now, processing performed if the control unit 1001 receives a SetConfiguration command reception event in step S1100 (RECEIVE SetConfiguration COMMAND in step S1100) will be described.

In step S1130, the control unit 1001 performs the SetConfiguration command processing. The SetConfiguration command processing is not illustrated in detail. During the SetConfiguration command processing, the control unit 1001 stores a PTZC 6140 specified in an argument in the received SetConfiguration command into the storage unit 1002, and returns a response to the client apparatus 2000.

After step S1130 is performed, the processing returns to step S1100. Now, processing performed if the control unit 1001 receives the image acquisition event in step S1100 (ACQUIRE IMAGE in step S1100) will be described.

In step S1101, the control unit 1001 performs the distribution image generation processing. The distribution image generation processing will be described in detail below.

In step S1102, the control unit 1001 performs distribution image transmission processing (a detailed description of the distribution image transmission processing is omitted here). During this distribution image transmission processing, the control unit 1001 distributes image data generated in the storage unit 1002 by the distribution image generation processing that will be described below, to the external apparatus requesting video transmission via the communication unit 1006 according to the sequence of transactions T6020 to T6023.

After step S1102 is performed, the processing returns to step S1100.

Now, processing performed if the control unit 1001 receives an AbsoluteMove command reception event in step S1100 (RECEIVE AbsoluteMove COMMAND in step S1100) will be described.

In step S1110, the control unit 1001 performs the AbsoluteMove command processing. The AbsoluteMove command processing will be described in detail below. After step S1110 is performed, the processing returns to step S1100.

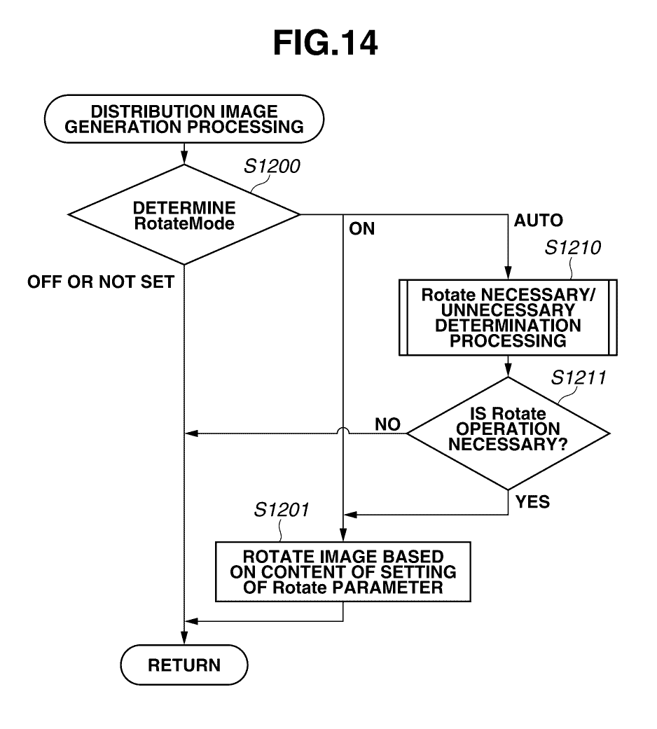

FIG. 14 is a flowchart illustrating the distribution image generation processing performed by the monitoring camera 1000.

In step S1200, the control unit 1001 determines the RotateMode included in the VSC 6120 stored into the storage unit 1002 during the SetVSC command processing. If the RotateMode is set to OFF, or the Rotate 6121 itself is not set (OFF OR NOT SET in step S1200), the processing illustrated in the present flowchart ends. In other words, in this case, the control unit 1001 uses the image data output from the imaging unit 1003 without rotating it. If the RotateMode is set to ON (ON in step S1200), the processing proceeds to step S1201. If the RotateMode is set to AUTO (Amp in step S1200), the processing proceeds to step S1210.

In step S1201, the control unit 1001 acquires the angle specified in the Degree included in the VSC 6120 stored in the storage unit 1002, rotates the image data output from the imaging unit 1003 to the storage unit 1002 clockwise by the angle specified in the Degree, and writes the rotated image data back into the storage unit 1002. At this time, in a case where the Degree is omitted, the control unit 1001 employs 180 degrees.

In step S1210, the control unit 1001 performs Rotate necessary/unnecessary determination processing to determine whether the image should be rotated, and acquire the angle by which the image should be rotated. A determination method used in this Rotate necessary/unnecessary determination processing can be realized by various kinds of methods, and a detailed description thereof is omitted herein. For example, the determination method may be realized in such a manner that the monitoring camera 1000 further includes a gravity sensor, and the control unit 1001 determines the direction in which the monitoring camera 1000 is installed from an output from the gravity sensor to determine the angle by which the image should be rotated. Alternatively, the determination method may be realized in such a manner that the monitoring camera 1000 includes a physical dial, and the control unit 1001 determines the angle by which the image should be rotated based on a rotation amount of the dial that is set by the user. Further alternatively, the determination method may be realized by determining whether the image should be rotated based on a dependency relationship with the other setting parameters. In the Rotate necessary/unnecessary determination processing, whether the Rotate operation is necessary is output, and the Degree information if the Rotate operation is necessary is output to the storage unit 1002.

In step S1211, the control unit 1001 determines a result of the Rotate necessary/unnecessary determination processing. If the control unit 1001 determines that the Rotate operation is necessary (YES in step S1211), the processing proceeds to step S1201. If the control unit 1001 determines that the Rotate operation is unnecessary (NO in step S1211), the processing illustrated in the present flowchart ends.

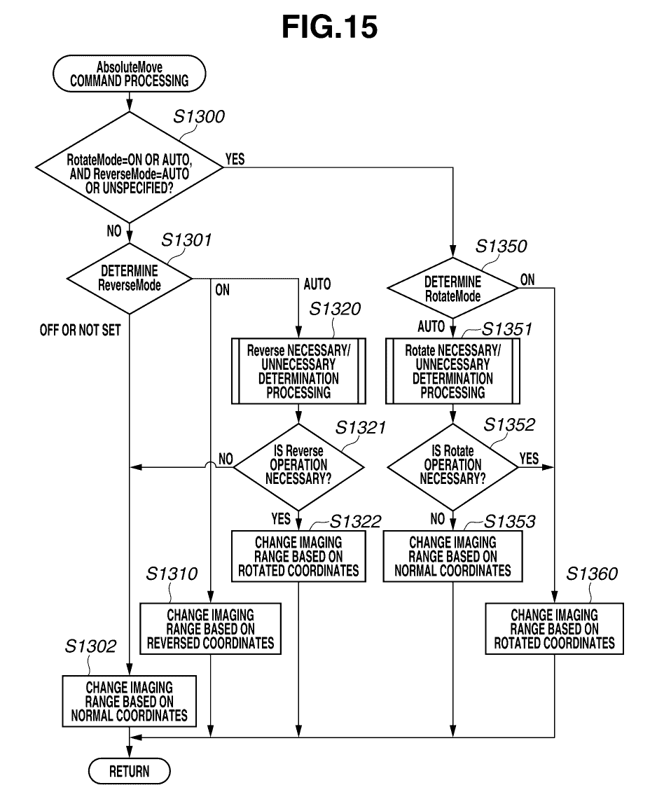

FIG. 15 is a flowchart illustrating the AbsoluteMove command reception processing performed by the monitoring camera 1000.

In step S1300, the control unit 1001 determines the RotateMode and the ReverseMode stored in the storage unit 1002. If the RotateMode is set to ON or AUTO and the ReverseMode is set to AUTO or is omitted (YES in step S1300), the processing proceeds to step S1350.

In step S1301, the control unit 1001 determines the ReverseMode stored in the storage unit 1002. If the ReverseMode is set to OFF or the Reverse 6141 itself is not set (OFF OR NOT SET in step S1301), the processing proceeds to step S1302. If the ReverseMode is set to ON (ON in step S1301), the processing proceeds to step S1310. If the ReverseMode is set to AUTO (AUTO in step S1301), the processing proceeds to step S1320.

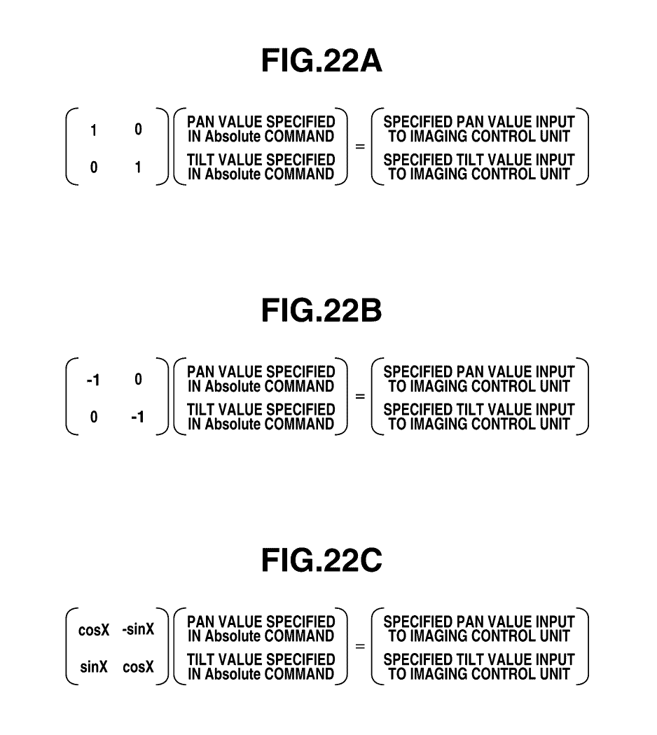

In step S1302, the control unit 1001 employs the pan and tilt coordinates included in the PTZC 6140 stored in the storage unit 1002 without reversing them. More specifically, the control unit 1001 inputs a pan coordinate value and a tilt coordinate value acquired from an argument in the AbsoluteMove command based on a calculation expression illustrated in FIG. 22A into the imaging control unit 1004 to cause the imaging control unit 1004 to change the imaging range.

In step S1310, the control unit 1001 rotates the pan and tilt coordinates included in the PTZC 6140 stored in the storage unit 1002 by 180 degrees, and employs the rotated pan and tilt coordinates. More specifically, the control unit 1001 inputs a pan coordinate value and a tilt coordinate value acquired from the argument in the AbsoluteMove command based on a calculation expression illustrated in FIG. 22B into the imaging control unit 1004 to cause the imaging control unit 1004 to change the imaging range.

In step S1320, the control unit 1001 performs Reverse necessary/unnecessary determination processing to determine whether the coordinates should be rotated, and acquire the angle by which the coordinates should be rotated. A determination method used in this Reverse necessary/unnecessary determination processing can be realized by various kinds of methods, and a detailed description thereof is omitted herein. For example, the determination method may be realized in such a manner that the monitoring camera 1000 further includes the gravity sensor, and the control unit 1001 determines the direction in which the monitoring camera 1000 is installed from the output from the gravity sensor to determine the angle by which the coordinates should be rotated. Alternatively, the determination method may be realized in such a manner that the monitoring camera 1000 includes a physical dial, and the control unit 1001 determines the angle by which the coordinates should be rotated based on a rotation amount of the dial that is set by the user. Further alternatively, the determination method may be realized by determining whether the coordinates should be rotated based on a dependency relationship with the other setting parameters. In the Reverse necessary/unnecessary determination processing, whether the Reverse operation is necessary is output, and the rotation angle information, if the Reverse operation is necessary, is output to the storage unit 1002.

In step S1321, the control unit 1001 determines a result of the Reverse necessary/unnecessary determination processing. If the control unit 1001 determines that the Reverse operation is necessary (YES in step S1321), the processing proceeds to step S1322. If the control unit 1001 determines that the Reverse operation is unnecessary (NO in step S1321), the processing proceeds to step S1302.

In step S1322, the control unit 1001 rotates the pan and tilt coordinates included in the PTZC 6140 by the angle value acquired in step S1320, and employs the rotated pan and tilt coordinates. More specifically, assuming that X represents the angle value, the control unit 1001 inputs a pan coordinate value and a tilt coordinate value acquired. from the argument in the AbsoluteMove command based on a calculation expression illustrated in FIG. 22C into the imaging control unit 1004 to cause the imaging control unit 1004 to change the imaging range.

In step S1350, the control unit 1001 determines the RotateMode included in the VSC 6120 stored in the storage unit 1002. If the RotateMode is set to ON (ON in step S1350), the processing proceeds to step S1360. If the RotateMode is set to AUTO (AUTO in step S1350), the processing proceeds to step S1351.

In step S1351, the control unit 1001 performs the Rotate necessary/unnecessary determination processing to determine whether the image should be rotated and acquire the angle by which the image should be rotated. In the Rotate necessary/unnecessary determination processing, whether the Rotate operation is necessary is output, and the Degree information if the Rotate operation is necessary is output to the storage unit 1002.

In step S1352, the control unit 1001 determines a result of the Rotate necessary/unnecessary determination processing. If the control unit 1001 determines that the Rotate operation is necessary (YES in step S1352), the processing proceeds to step S1360. If the control unit 1001 determines that the Rotate operation is unnecessary (NO in step S1352), the processing proceeds to step S1353.

In step S1353, the control unit 1001 employs the pan and tilt coordinates included in the PTZC 6140 stored in the storage unit 1002 without rotating them. More specifically, the control unit 1001 inputs the pan coordinate value and the tilt coordinate value acquired from the argument in the AbsoluteMove command based on the calculation expression illustrated in FIG. 22A into the imaging control unit 1004 to cause the imaging control unit 1004 to change the imaging range.

In step S1360, the control unit 1001 acquires the angle specified in the Degree included in the VSC 6120 stored in the storage unit 1002, and rotates the pan and tilt coordinates included in the PTZC 6140 by the angle specified in the Degree to employ the rotated pan and tilt coordinates. More specifically, the control unit 1001 converts the pan coordinate value and the tilt coordinate value acquired from the argument in the AbsoluteMove command based on the calculation expression illustrated in FIG. 22C assuming that X represents the value specified in the Degree, and inputs the converted values into the imaging control unit 1004 to thereby cause the imaging control unit 1004 to change the imaging range.

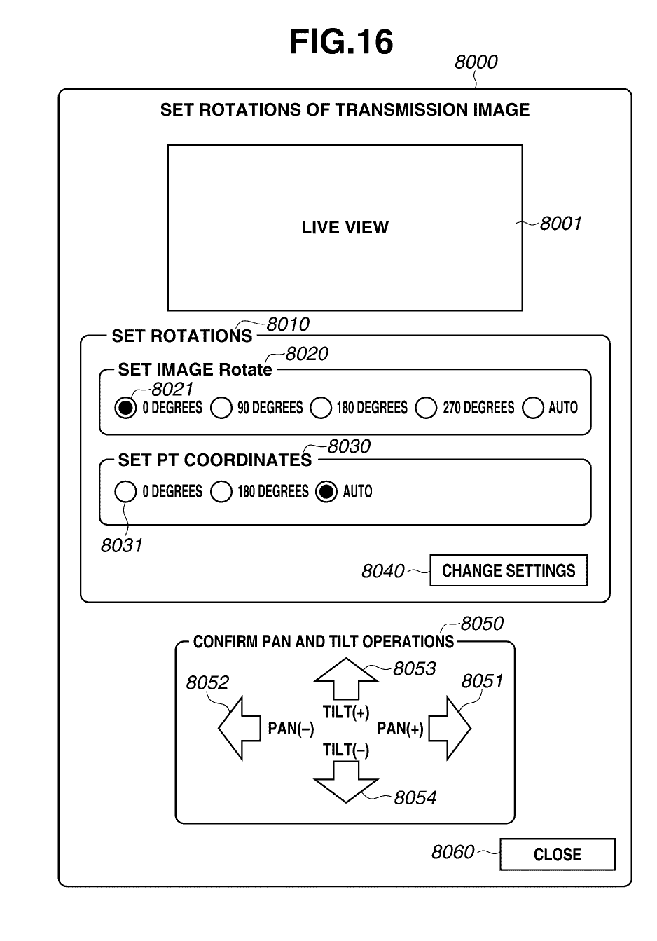

FIG. 16 illustrates an example of a distribution image rotation setting screen of the client apparatus 2000 that is used to set the rotation of the image to be transmitted from the monitoring camera 1000.

FIG. 16 illustrates a distribution image rotation setting screen 8000. The distribution image rotation setting screen 8000 includes a live view area 8001. When this setting screen is opened on the client apparatus 2000, the client apparatus 2000 performs the transactions illustrated in FIG. 8 to acquire a video stream from the monitoring camera 1000 to display the acquired video stream. The distribution image rotation setting screen 8000 further includes an area 8010 for inputting the parameters for the rotation settings. The area 8010 includes an image Rotate setting area 8020. A value set in this area is set to the Rotate 6121 in the VSC 6120. Radio buttons 8021 indicate the options for the RotateMode and the Degree. The area 8010 further includes a PT coordinate setting area 8030. A value set in this area is set to the Reverse 6141 in the PTZC 6140. Radio buttons 8031 indicate the options for the ReverseMode. A button 8040 is a setting change button. By this button, contents of the rotation settings 8010 are transmitted to the monitoring camera 1000 and are reflected therein. The distribution image rotation setting screen 8000 further includes a pan and tilt operation confirmation area 8050. This area 8050 includes a pan(+) button 8051. The area 8050 further includes a pan(−) button 8052. The area 8050 further includes a tilt(+) button 8053. The area 8050 further includes a tilt(−) button 8054. Pressing the buttons 8051 to 8054 causes the AbsoluteMove command for changing the imaging range according to each of the buttons 8051 to 8054 to be issued to the monitoring camera 1000. For example, when the button 8052 is pressed, the AbsoluteMove command with (the pan coordinate, the tilt coordinate)=(−0.1, 0.0) set in the argument is transmitted to the monitoring camera 1000. A close button 8060 is used to close the present screen.

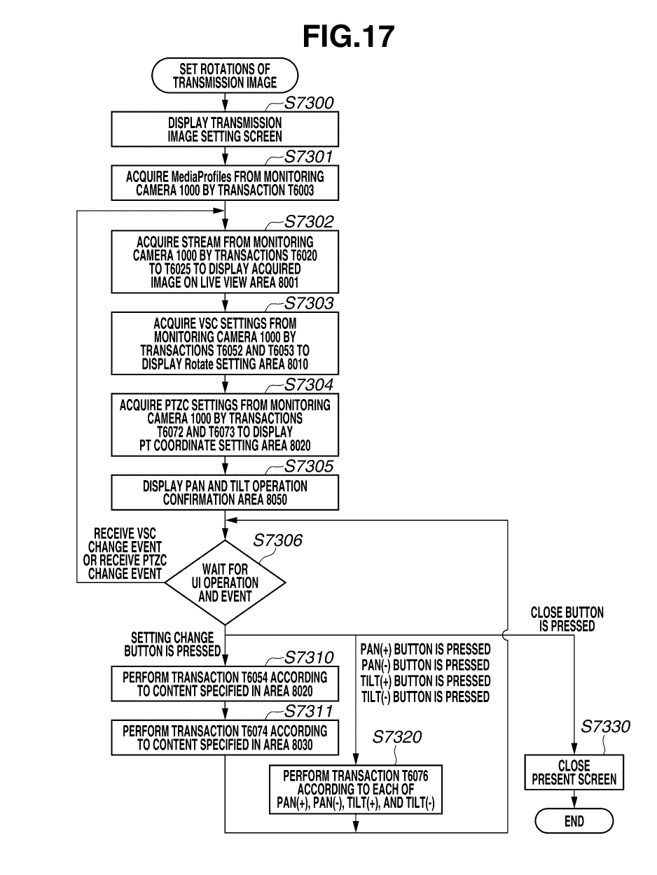

FIG. 17 is a flowchart illustrating how the client apparatus 2000 operates with respect to the distribution image rotation setting screen 8000.

In step S7300, the control unit 2001 displays the distribution image rotation setting screen 8000 on the display unit 2003.

In step S7301, the control unit 2001 performs the GetProfiles transaction indicated in transaction T6003 via the communication unit 2006 to acquire the list of MediaProfiles 6100 from the monitoring camera 1000.

In step S7302, the control unit 2001 performs the transactions indicated in transactions T6020 to T6025 with use of the MediaProfile 6100 acquired in step S7301 to acquire the video stream from the monitoring camera 1000. The control unit 2001 displays the received video image on the live view area 8001.

In step S7303, the control unit 2001 performs the transactions indicated in transactions T6052 and T6053 to acquire the options for the respective parameters of the Rotate 6121 that are settable to the VSC 6120 from the monitoring camera 1000. The control unit 2001 displays the content of the image Rotate setting area 8020 based on the acquired options for the parameters included in the VSC 6120. More specifically, the control unit 2001 determines the RotateMode that the monitoring camera 1000 can accept, and lists the acceptable options for the Degree in the image Rotate setting area 8020 if the monitoring camera 1000 supports the option ON of the RotateMode. In the example illustrated in FIG. 16, 0 degrees, 90 degrees, 180 degrees, and 270 degrees are listed as the acceptable options. The control unit 2001 displays the option AUTO in the image Rotate setting area 8020 if the monitoring camera 1000 supports the option AUTO of the RotateMode.

In step S7304, the control unit 2001 performs the transactions indicated in transactions T6072 and T6073 to acquire the options for the ReverseMode that are settable to the PTZC 6140 from the monitoring camera 1000. The control unit 2001 displays the content of the PT coordinate setting area 8030 based on the acquired options for the ReverseMode. More specifically, the control unit 2001 determines the ReverseMode that the monitoring camera 1000 can accept, and lists 0 degrees and 180 degrees as the options as illustrated in FIG. 16 if the monitoring camera 1000 supports the option ON of the ReverseMode. The control unit 2001 displays the option AUTO in the PT coordinate setting area 8030 if the monitoring camera 1000 supports the option AUTO of the ReverseMode.

In step S7306, the control unit 2001 waits for occurrence of various kinds of events. If the control unit 2001 receives a VSC change event or a PTZC change event transmitted by the monitoring camera 1000 from the communication unit 2006 (RECEIVE VSC CHANGE EVENT OR RECEIVE PTZC CHANGE EVENT in step S7306), the processing returns to step S7301. If the control unit 2001 receives an event of pressing the setting change button 8040 from the input unit 2004 (SETTING CHANGE BUTTON IS PRESSED in step S7306), the processing proceeds to step S7310. If the control unit 2001 receives an event of pressing the pan and tilt buttons 8051 to 8054 from the input, unit 2004 (PAN(+) BUTTON IS PRESSED, PAN(−) BUTTON IS PRESSED, TILT(+) BUTTON IS PRESSED, AND/OR TILT(−) BUTTON IS PRESSED in step S7306), the processing proceeds to step S7320. If the control unit 2001 receives an event of pressing the close button 8060 from the input unit 2004 (CLOSE BUTTON IS PRESSED in step S7306), the processing proceeds to step S7330.

In step S7310, the control unit 2001 performs transaction T6054 of transmitting the SetVSC command while specifying the content of the image Rotate setting area 8020 as the Rotate value contained in the argument in the SetVSC command.

In step S7311, the control unit 2001 performs transaction T6074 of transmitting the SetConfiguration command while specifying the content of the PT coordinate setting area 8030 as the Reverse value contained in the argument in the SetConfiguration command. Then, the processing returns to step S7306.

In step S7320, the control unit 2001 performs transaction T6076 of transmitting the

AbsoluteMove command according to each of the pan(+) button 8051, the pan(−) button 8052, the tilt(+) button 8053, and the tilt(−) button 8054. Then, the processing returns to step S7306.

In step S7330, the control unit 2001 closes the present distribution image rotation setting screen 8000. Then, the processing of the present flowchart ends.

In this manner, as described above, the present exemplary embodiment can provide an imaging apparatus characterized in that, when one of rotation angles is specified and the other of the rotation angles is not specified by a first interface configured to change a rotation angle of an image rotation unit according to an external command and a second interface configured to change a rotation angle of a coordinate rotation unit according to an external command, the imaging apparatus performs control so as to determine the both rotation angles based on this specified rotation angle.

Further, the imaging apparatus is characterized in that the first interface and the second interface each include four options, a rotation angle specifying option for specifying a certain single angle as the rotation angle, a rotation disablement specifying option for specifying no rotation, an automatic setting specifying option for causing the imaging apparatus to determine the rotation angle, and a specifying omission option for not specifying whether a rotation is necessary as options for specifying the rotation angle, and when the rotation angle specifying option or the automatic setting specifying option is selected for the one of the rotation angles by the first interface or the second interface and the automatic setting specifying option or the specifying omission option is selected for the other of the rotation angles by the first interface or the second interface, the imaging apparatus performs the control so as to determine the both rotation angles based on this specified rotation angle.

Further, the imaging apparatus is characterized in that, when the automatic setting specifying option is selected by the first interface and the second interface, the imaging apparatus determines the rotation angle of the image and the rotation angle of the coordinate independently of each other.

In this manner, as described above, according to the present exemplary embodiment, when the distribution image is rotated by 90 degrees, 180 degrees, or 270 degrees with the imaging apparatus installed in a sideways orientation, it becomes possible to also appropriately rotate the pan and tilt coordinates. As a result, it becomes possible to desirably control the processing for rotating the output image and the command for changing the imaging range for both the external apparatus that operates the orientation of the output image and the orientation of the coordinate system regarding the command for changing the imaging range independently of each other, and the external apparatus that operates the both orientations by one of the commands.

### Second Exemplary Embodiment

As the first exemplary embodiment, an exemplary embodiment of the present invention has been described based on the monitoring camera 1000 that switches whether the pan-tilt coordinate system should be rotated according to the current setting value of the Reverse 6141 when the setting of the Rotate 6121 is changed.

However, the monitoring camera 1000 may be configured to switch whether the distribution image should be rotated according to the setting value of the Rotate 6121 when the setting of the Reverse 6141 is changed. This configuration may be used to desirably control the processing for rotating the output image and the command for changing the imaging range for both the external apparatus that operates the orientation of the output image and the orientation of the coordinate system regarding the command for changing the imaging range independently of each other, and the external apparatus that operates the both orientations by one of the commands.

A second exemplary embodiment of the present invention that is configured in consideration of the above-described possible alternative will be described below. Features of the second exemplary embodiment similar to those of the first exemplary embodiment will not be described in detail below.

FIG. 1 is a system configuration diagram illustrating an imaging system including a monitoring camera 1000 (i.e., imaging apparatus) and a client apparatus 2000 according to the second exemplary embodiment of the present invention.

FIG. 2A illustrates an internal configuration of the monitoring camera 1000.

FIG. 2B illustrates an internal configuration of the client apparatus 2000.

FIG. 3 illustrates a structure of parameters that the monitoring camera 1000 has according to the present exemplary embodiment.

FIGS. 4A, 4B, and 4C, FIG. 5, and FIGS. 6A, 6B, and 6C illustrate details of arguments in various commands transmitted and received between the monitoring camera 1000 and the client apparatus 2000, and details of the parameters.

FIGS. 7, 8, 9, and 10 illustrate typical command sequences performed between the monitoring camera 1000 and the client apparatus 2000.

FIG. 11 illustrates examples of an image that the monitoring camera 1000 distributes based on the Rotate 6121 in the VSC 6120.

FIG. 12 illustrates examples of positions of an imaging range when the monitoring camera 1000 performs processing regarding the AbsoluteMove command based on the Reverse 6141 in the PTZC 6140.

FIG. 13 is a flowchart illustrating main processing performed by the monitoring camera 1000.

FIG. 16 illustrates an example of a distribution image rotation setting screen of the client apparatus 2000 that is used to set a rotation of the image to be transmitted from the monitoring camera 1000.

FIG. 17 is a flowchart illustrating how the client apparatus 2000 operates with respect to the distribution image rotation setting screen 8000.

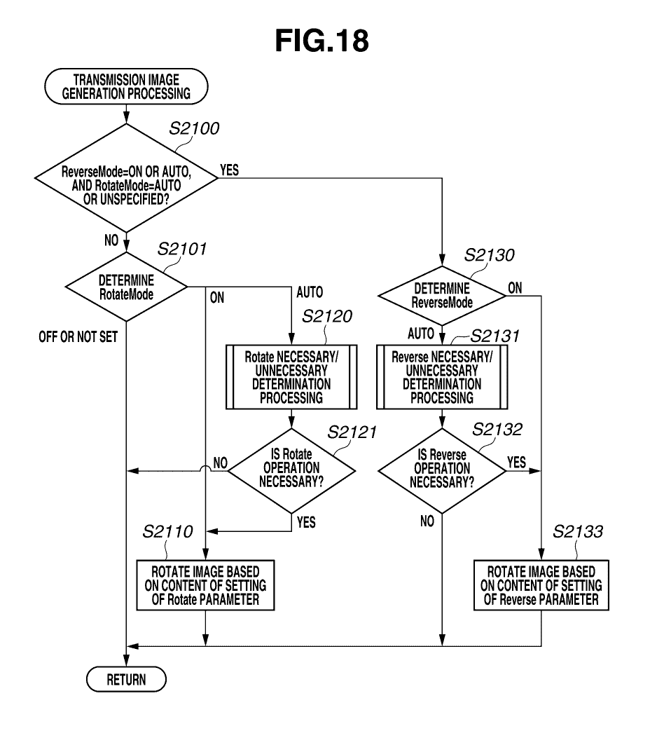

FIG. 18 is a flowchart illustrating distribution image generation processing performed by the monitoring camera 1000.

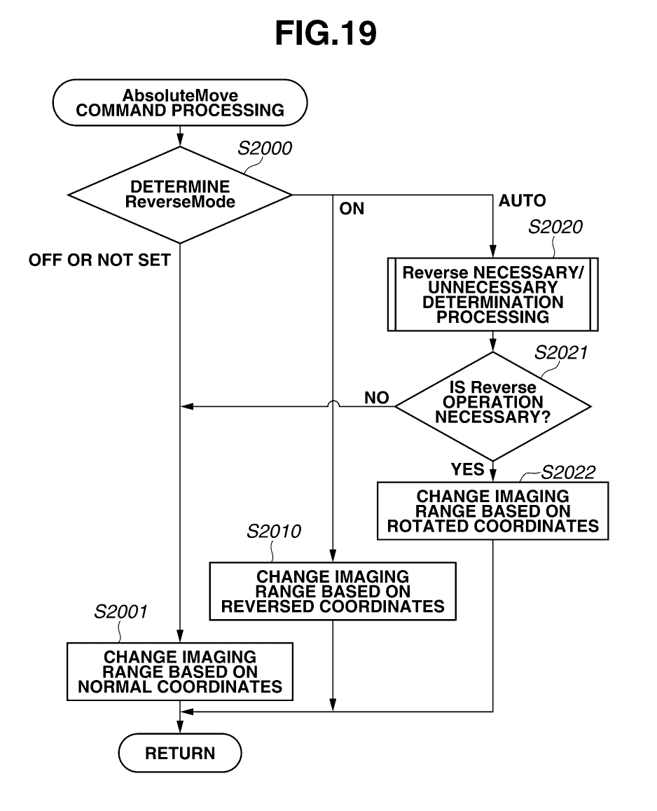

FIG. 19 is a flowchart illustrating AbsoluteMove command reception processing performed by the monitoring camera 1000.

FIGS. 22A, 22B, and 22C illustrate conversion calculation expressions for converting pan and tilt coordinate values.

FIG. 18 is the flowchart illustrating the distribution image generation processing performed by the monitoring camera 1000.

In step S2100, the control unit 1001 determines the RotateMode and the ReverseMode stored in the storage unit 1002. If the ReverseMode is set to ON or AUTO and the RotateMode is set to AUTO or is omitted (YES in step S2100), the processing proceeds to step S2130.

In step S2101, the control unit 1001 determines the RotateMode stored in the storage unit 1002. If the RotateMode is set to OFF or the Rotate 6121 itself is not set (OFF OR NOT SET in step S2101), the processing illustrated in the present flowchart ends. In other words, in this case, the control unit 1001 uses the image data output from the imaging unit 1003 without rotating it. If the RotateMode is set to ON (ON in step S2101), the processing proceeds to step S2110. If the RotateMode is set to AUTO (AUTO in step S2101), the processing proceeds to step S2120.

In step S2110, the control unit 1001 acquires the angle specified in the Degree included in the VSC 6120 stored in the storage unit 1002, rotates the image data output from the imaging unit 1003 to the storage unit 1002 clockwise by the angle specified in the Degree, and writes the rotated image data back into the storage unit 1002. At this time, if the Degree is omitted, the control unit 1001 employs 180 degrees. Then, the processing of the present flowchart ends.

In step S2120, the control unit 1001 performs the Rotate necessary/unnecessary determination processing to determine whether the image should be rotated and acquire the angle by which the image should be rotated. The details of this processing are as described in the description of step S1210.

In step S2121, the control unit 1001 determines a result of the Rotate necessary/unnecessary determination processing. if the control unit 1001 determines that the Rotate operation is necessary (YES in step S2121), the processing proceeds to step S2110. If the control unit 1001 determines that the Rotate operation is unnecessary (NO in step S2121) the processing of the present flowchart ends.

The control unit 1001 rotates the pan and tilt coordinates included in the PTZC 6140 stored in the storage unit 1002 by 180 degrees, and employs the rotated pan and tilt coordinates. More specifically, the control unit 1001 inputs the pan coordinate value and the tilt coordinate value acquired from the argument in the AbsoluteMove command based on the calculation expression illustrated in FIG. 22B into the imaging control unit 1004 to cause the imaging control unit 1004 to change the imaging range.

In step S2130, the control unit 1001 determines the ReverseMode included in the PTZC 6140 stored into the storage unit 1002 in the SetConfiguration command processing. If the ReverseMode is set to ON (ON in step S2130), the processing proceeds to step S2133. If the ReverseMode is set to AUTO (AUTO in step S2130), the processing proceeds to step S2131.

In step S2131, the control unit 1001 performs the Reverse necessary/unnecessary determination processing to determine whether the image should be rotated and acquire the angle by which the image should be rotated. The details of this processing are as described in the description of step S1320.

In step S2132, the control unit 1001 determines a result of the Reverse necessary/unnecessary determination processing. If the control unit 1001 determines that the Reverse operation is necessary (YES in step S2132), the processing proceeds to step S2133, If the control unit 1001 determines that the Reverse operation is unnecessary (NO in step S2132), the processing of the present flowchart ends.

In step S2133, the control unit 1001 rotates the image data output from the imaging unit 1003 to the storage unit 1002 by the angle value acquired in step S2131, and writes the rotated image data back into the storage unit 1002.

FIG. 19 is the flowchart illustrating the AbsoluteMove command reception processing performed by the monitoring camera 1000.

In step S2000, the control unit 1001 determines the ReverseMode included in the PTZC 6140 stored into the storage unit 1002 during the SetConfiguration command processing. If the ReverseMode is set to OFF or the Reverse 6141 itself is not set (OFF OR NOT SET in step S2000), the processing proceeds to step S2001. If the ReverseMode is set to ON (ON in step S2000), the processing proceeds to step S2010. If the ReverseMode is set to AUTO (AUTO in step S2000), the processing proceeds to step S2020.

In step S2001, the control unit 1001 employs the pan and tilt coordinates included in the PTZC 6140 stored in the storage unit 1002 without reversing them. More specifically, the control unit 1001 inputs the pan coordinate value and the tilt coordinate value acquired from the argument in the AbsoluteMove command based on the calculation expression illustrated in FIG. 22A into the imaging control unit 1004 to cause the imaging control unit 1004 to change the imaging range. Then, the processing of the present flowchart ends.

In step S2010, the control unit 1001 rotates the pan and tilt coordinates included in the PTZC 6140 stored in the storage unit 1002 by 180 degrees, and employs the rotated pan and tilt coordinates. More specifically, the control unit 1001 inputs the pan coordinate value and the tilt coordinate value acquired from the argument in the AbsoluteMove command based on the calculation expression illustrated in FIG. 22B into the imaging control unit 1004 to cause the imaging control unit 1004 to change the imaging range. Then, the processing of the present flowchart ends.

In step S2020, the control unit 1001 performs the Reverse necessary/unnecessary determination processing to determine whether the coordinates should be rotated and acquire the angle by which the coordinates should be rotated. The details of this processing are as described in the description of step S1320.

In step S2021, the control unit 1001 determines a result of the Reverse necessary/unnecessary determination processing. If the control unit 1001 determines that the Reverse operation is necessary (YES in step S2021), the processing proceeds to step S2022. if the control unit 1001 determines that the Reverse operation is unnecessary (NO in step S2021), the processing proceeds to step S2001.

In step S2022, the control unit 1001 rotates the pan and tilt coordinates included in the PTZC 6140 by the angle value acquired in step S2020, and employs the rotated pan and tilt coordinates. More specifically, assuming that X represents the angle value, the control unit 1001 inputs the pan coordinate value and the tilt coordinate value acquired from the argument in the AbsoluteMove command based on the calculation expression illustrated in FIG. 22C into the imaging control unit 1004 to cause the imaging control unit 1004 to change the imaging range.

In this manner, according to the above-described imaging apparatus, when the pan and tilt coordinates are rotated with the imaging apparatus installed in an orientation that is not the normal direction such as the sideways orientation and the reverse orientation, it becomes possible to also appropriately rotate the distribution image. As a result, it becomes possible to desirably control the processing for rotating the output image and the command for changing the imaging range for both the external apparatus that operates the orientation of the output image and the orientation of the coordinate system regarding the command for changing the imaging range independently of each other, and the external apparatus that operates the both orientations by one of the commands.

### Third Exemplary Embodiment

As the first and second exemplary embodiments, examples of the present invention have been described based on the monitoring camera 1000 that switches, based on the current setting value of the Rotate 6121 or the current setting value of the Reverse 6141, whether the other rotation is necessary.

However, in the first and second exemplary embodiments, when the both setting values are set to AUTO, the monitoring camera 1000 employs the content of the Rotate necessary/unnecessary determination processing as the setting values of the both rotations according to the first exemplary embodiment, while the monitoring camera 1000 employs the content of the Reverse necessary/unnecessary determination processing as the setting values of the both rotations according to the second exemplary embodiment. In other words, the first and second exemplary embodiments are configured in such a manner that, when the both setting values are set to AUTO, the monitoring camera 1000 prioritizes any one of the Rotate necessary/unnecessary determination processing and the Reverse necessary/unnecessary determination processing. However, the present invention is not limited thereto. One exemplary embodiment of the present invention may be configured in such a manner that, when the both Reverse 6141 and Rotate 6121 are set to AUTO, the respective rotation settings are determined based on the Reverse necessary/unnecessary determination processing and the Rotate necessary/unnecessary determination processing, respectively.

A third exemplary embodiment of the present invention that is configured in consideration of the above-described possible alternative will be described below. Features of the third exemplary embodiment similar to those of the first and second exemplary embodiments will not be described in detail below.

FIG. 1 is a system configuration diagram illustrating an imaging system including a monitoring camera 1000 (i.e., imaging apparatus) and a client apparatus 2000 according to the third exemplary embodiment of the present invention.

FIG. 2A illustrates an internal configuration of the monitoring camera 1000.

FIG. 2B illustrates an internal configuration of the client apparatus 2000.

FIG. 3 illustrates a structure of parameters that the monitoring camera 1000 has according to the present exemplary embodiment.

FIGS. 4A, 4B, and 4C, FIG. 5, and. FIGS. 6A, 6B, and 6C illustrate details of arguments in various commands transmitted and received between the monitoring camera 1000 and the client apparatus 2000, and details of the parameters.

FIGS. 7, 8, 9, and 10 illustrate typical command sequences performed between the monitoring camera 1000 and the client apparatus 2000.

FIG. 11 illustrates examples of an image that the monitoring camera 1000 distributes based on the Rotate 6121 in the VSC 6120.

FIG. 12 illustrates examples of positions of an imaging range when the monitoring camera 1000 performs processing regarding the AbsoluteMove command based on the Reverse 6141 in the PTZC 6140.

FIG. 13 is a flowchart illustrating main processing performed by the monitoring camera 1000.

FIG. 16 illustrates an example of a distribution image rotation setting screen of the client apparatus 2000 that is used to set a rotation of the image to be transmitted from the monitoring camera 1000.

FIG. 17 is a flowchart illustrating how the client apparatus 2000 operates with respect to the distribution image rotation setting screen 8000.

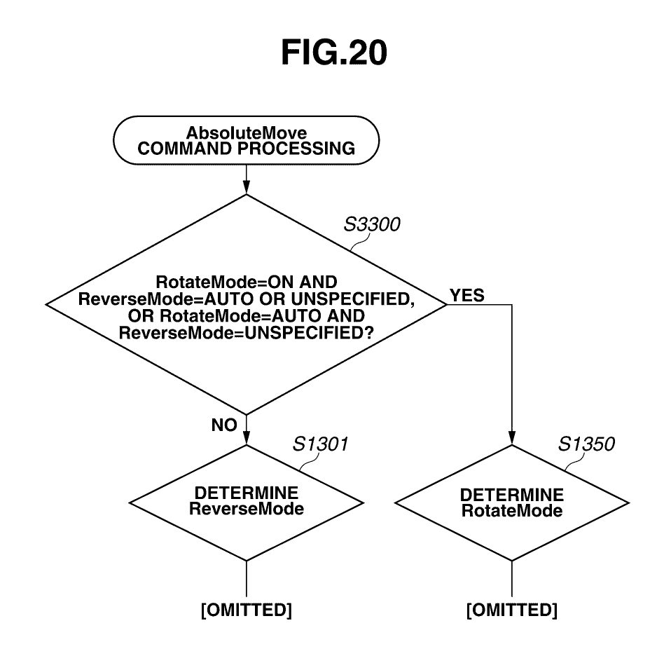

FIG. 20 is a flowchart illustrating AbsoluteMove command reception processing performed by the monitoring camera 1000.

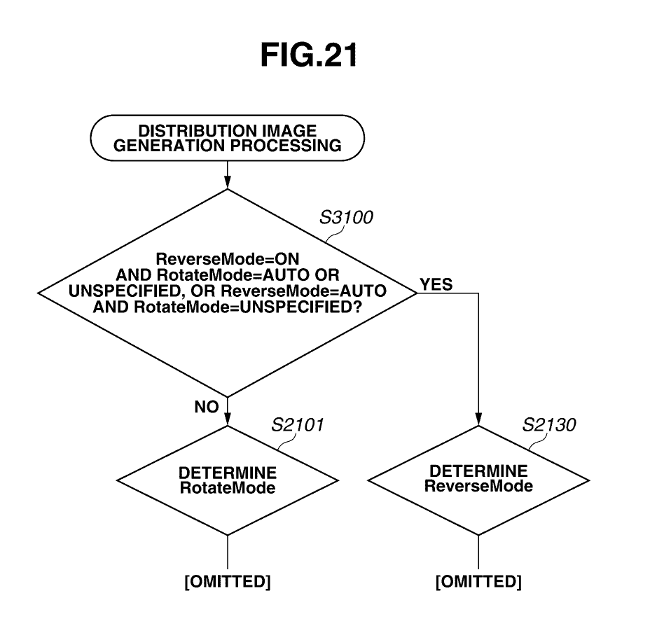

FIG. 21 is a flowchart illustrating distribution image generation processing performed by the monitoring camera 1000.

FIGS. 22A, 22B, and 22C illustrate conversion calculation expressions for converting pan and tilt coordinate values.

FIG. 20 is the flowchart illustrating the AbsoluteMove command reception processing performed by the monitoring camera 1000.

In step S3300, the control unit 1001 determines the RotateMode and the ReverseMode stored in the storage unit 1002. If the RotateMode is set to ON or AUTO and the ReverseMode is omitted (YES in step S3300), the processing proceeds to step S1350. Similarly, if the RotateMode is set to ON and the ReverseMode is set to AUTO (YES in step S3300), the processing proceeds to step S1350. In other cases (NO in step S3300), the processing proceeds to step S1301.

Processing after that is similar to that in FIG. 15, and therefore a description thereof is omitted here.

FIG. 21 is the flowchart illustrating the distribution image generation processing performed by the monitoring camera 1000.

In step S3100, the control unit 1001 determines the RotateMode and the ReverseMode stored in the storage unit 1002. If the ReverseMode is set to ON or AUTO and the RotateMode is omitted (YES in step S3100), the processing proceeds to step S2130. Similarly, if the ReverseMode is set to ON and the RotateMode is set to AUTO (YES in step S3100), the processing proceeds to step S2130. In other cases (NO in step S3100), the processing proceeds to step S2101.

Processing after that is similar to that in FIG. 18, and therefore a description thereof is omitted here.

In this manner, according to the above-described imaging apparatus, it becomes possible to appropriately set both the rotation of the pan and tilt coordinates and the rotation of the distribution image even when both the rotation of the pan and tilt coordinates and the rotation of the distribution image are set to the automatic settings with the imaging apparatus installed in an orientation that is not the normal direction such as the sideways orientation and the reverse orientation. As a result, it becomes possible to desirably control the processing for rotating the output image and the command for changing the imaging range.

The above-described exemplary embodiments can be also realized by performing the following processing. Specifically, the above-described exemplary embodiments can be realized by processing for supplying software (a program) for achieving the functions of the above-described exemplary embodiments to a system or an apparatus via a network or various kinds of storage media, and causing a computer (or a CPU, a micro processing unit (MPU), or the like) of this system or apparatus to read out and execute the program.

Having described the present invention in detail based on the exemplary embodiments thereof, the present invention is not limited to these specific exemplary embodiments, and the present invention also includes various kinds of embodiments configured without departing from the scope and the spirit of the present invention.

For example, the present invention also includes the following modifications.

1) The monitoring camera 1000 described in each of the exemplary embodiments of the present invention is configured to have a single VSC 6120, but the present invention is not limited thereto. The monitoring camera 1000 may have a plurality of VSCs 6120.

2) The monitoring camera 1000 described in each of the exemplary embodiments of the present invention has 90 degrees, 180 degrees, and 270 degrees as the options prepared for the user with respect to the image rotation, but the present invention is not limited thereto. The monitoring camera 1000 may be configured to allow the user to specify an arbitrary rotation angle.

3) The monitoring system described in each of the exemplary embodiments of the present invention has been described assuming that the monitoring system uses the AbsoluteMove command for specifying an absolute position in the entire imaging range as the command for changing the imaging range, but the present invention is not limited thereto. The monitoring system may use similar another command for changing the imaging range, such as a RelativeMove command for specifying the imaging range by specifying a relative position in the entire imaging range relative to the current imaging range.

According to the present invention, it becomes possible to desirably control the processing for rotating the output image and the command for changing the imaging range for both the external apparatus that operates the orientation of the output image and the orientation of the coordinate system regarding the command for changing the imaging range independently of each other, and the external apparatus that operates the both orientations by one of the commands. Further, it becomes possible to prevent inconsistency from occurring between the orientation of the output image and the orientation of the coordinate system regarding the command for changing the imaging range.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-054183 filed Mar. 17, 2014, which is hereby incorporated by reference herein in its entirety.

1. An imaging apparatus comprising:
an imaging unit configured to capture an image of an object that is formed by an imaging optical system;
an image rotation unit configured to rotate the captured image captured by the imaging unit;
an imaging range change unit configured to change an imaging range of the imaging unit according to an external command;
a coordinate rotation unit configured to rotate a coordinate used for changing a position of the imaging range by the imaging range change unit;
a first parameter setting unit configured to change a rotation angle of the image rotation unit according to an external command; and
a second parameter setting unit configured to change a rotation angle of the coordinate rotation unit according to an external command,
wherein, in a case where one of the rotation angles is specified by the first parameter setting unit or the second parameter setting unit and the other of the rotation angles is not specified by the first parameter setting unit or the second parameter setting unit, the imaging apparatus performs control so as to determine the both rotation angles based on the specified rotation angle.

2. The imaging apparatus according to claim 1, further comprising a determination unit configured to determine specified contents specified by the first parameter setting unit and the second parameter setting unit, wherein the imaging apparatus controls the rotation angles based on a result of the determination by the determination unit.

3. The imaging apparatus according to claim 1, wherein the first parameter setting unit and the second parameter setting unit each have four options of a rotation angle specifying option for specifying a certain single angle as the rotation angle, a rotation disablement specifying option for specifying no rotation, an automatic setting specifying option for causing the imaging apparatus to determine the rotation angle, and a specifying omission option for not specifying whether a rotation is necessary as options for specifying the rotation angle, and
wherein, in a case where the rotation angle specifying option or the automatic setting specifying option is selected for the one of the rotation angles by the first parameter setting unit or the second parameter setting unit and the automatic setting specifying option or the specifying omission option is selected for the other of the rotation angles by the first parameter setting unit or the second parameter setting unit, the imaging apparatus performs the control so as to determine the both rotation angles based on this specified rotation angle.

4. The imaging apparatus according to any one of claims 1, wherein, in a case where the automatic setting specifying option is selected by the first parameter setting unit and the second parameter setting unit, the imaging apparatus determines the rotation angle of the image and the rotation angle of the coordinate independently of each other.

5. A method for controlling an imaging apparatus, the method comprising:
capturing an image of an object that is formed by an imaging optical system;
rotating the captured image;
changing an imaging range of the image capturing according to an external command;
rotating a coordinate used for changing a position of the imaging range;
changing a rotation angle of the image rotating according to an external command as a first parameter setting;
changing a rotation angle of the coordinate rotating according to an external command as a second parameter setting; and
wherein both of the rotation angles are determined based on the specified rotation angle when one of the rotation angles is specified by the first parameter setting or the second parameter setting and the other of the rotation angles is not specified by the first parameter setting or the second parameter setting.
